(19) United States
(12) Patent Application Publication
(10) Pub. No.: US 2007/0021565 A1
(43) Pub. Date: Jan. 25, 2007

(54) Epdm composition

(76) Inventors: Satoshi Horie, Kumamoto (JP); Masashi Kudo, Kanagawa (JP); Kenichi Fujimoto, Kanagawa (JP)

Correspondence Address: BUTZEL LONG, 350 SOUTH MAIN STREET, SUITE 300, ANN ARBOR, MI, 48104, US

(21) Appl. No.: 10/569,348

(22) PCT Filed: Sep. 29, 2004
(86) PCT No.: PCT/JP04/14247

§ 371 Date: Feb. 22, 2006

(30) Foreign Application Priority Data
Nov. 11, 2003 (JP) 2003-380695

(51) Int. Cl. C08F 8/00

(52) U.S. Cl. 525/192

(57) ABSTRACT

An EPDM composition, which comprises a blend rubber comprising 100 parts by weight of blend rubber consisting of 20-80% by weight of EPDM containing 5-ethylidene-2-norbornene [ENB] as one type of diene component and 80-20% by weight of EPDM containing dicyclopentadiene [DCPD] as another type of diene component, and 0.5-10 parts by weight of an organic peroxide. Seal parts obtained by vulcanization molding of the EPDM composition show well balanced characteristics, even if dipped in hot water at high temperatures such as 200° C. for 500 hours or 300° C. for 24 hours, particularly with improved compression set characteristics.

### TECHNICAL FIELD

The present invention relates to an EPDM composition. More particularly, the invention relates to an EPDM composition preferably for use as vulcanization-molding materials for hot water-resistant seal parts.

### BACKGROUND ART

In one aspect, the longevity of seal parts such as gaskets, packings, O rings, etc. depends mainly on compression set characteristics. Thus, the compression set characteristics of seal parts can serve as an important characteristic value and can be considered as an index of longevity. The compression set characteristics depend not only on formulation of rubber components, but in case of EPDM (ethylene•propylene•diene copolymerization rubber) they also depend on the type of copolymerized diene component.

The diene component for use in EPDM includes several types. Typically, 5-ethylidene-2-norbornene [ENB], dicyclopentadiene [DCPD], vinylydene norbonene [VNB], etc. can be used. However, ENB-copolymerized EPDM has a poor hot water resistance at 250° C. or higher, DCPD-copolymerized EPDM has poor compression set characteristics, and VNB-copolymerized EPDM has a poor tensile strength, as disadvantages, respectively. In production of hot water-resistant seal parts of long longevity and high performance, EPDM produced by copolymerization of any type of such diene components have not been satisfactory owing to said disadvantages.

Patent literature 1: JP-A-2001-146537

Patent Literature 2: JP-A-2003-128851

### DISCLOSURE OF THE INVENTION

### Problem to be Solved by the Invention

An object of the present invention is to provide an EPDM composition that can provide a good resistance to hot water at high temperatures such as 200° C. or higher.

### MEANS FOR SOLVING THE PROBLEM

The object of the present invention can be attained by an EPDM composition, which comprises 100 parts by weight of blended rubber consisting of 20-80% by weight of EPDM containing 5-ethylidene-2-norbornene [ENB] as one type of diene component and 80-20% by weight of EPDM containing dicyclopentadiene [DCPD] as another type of diene component, and 0.5-10 parts by weight of an organic peroxide.

### EFFECT OF THE INVENTION

Seal parts produced by vulcanization molding the present EPDM composition, even if dipped into hot water at such high temperatures such as 200° C. for 500 hours or 300° C. for 24 hours, show well-balanced characteristics, particularly with improved compression set characteristics.

Specifically, the product longevity of seal parts can be determined mainly by the compression set characteristics, and the time when the characteristics reach a value of about 80% can be judged to be the longevity. Seal parts produced from the present EPDM composition can provide a higher improvement in the compression set by about 10% than that of the conventional ones at the same temperatures. Indeed, the longevity of the conventional one is 10 hours when dipped in hot water at 300° C., whereas the seal parts produced from the present EPDM composition can maintain a good sealability even after 24 hours, and thus have a satisfactory hot water resistance.

### BEST MODES FOR CARRYING OUT THE INVENTION

ENB-copolymerized EPDM and DCPD-copolymerized EPDM are used as a blend in a proportion of the former to the latter of 20-80 wt. % to 80-20 wt. %, preferably 30-70 wt. % to 70-30 wt. %. The compression set characteristics can be improved by increasing the proportion of the former in the blend, whereas the hot water resistance can be improved by increasing the proportion of the latter in the blend. Seal parts, etc. that can meet the desired use purpose can be obtained by changing the blending-proportion within said range.

An organic peroxide as a cross-linking agent can be used in a ratio of about 0.5 to about 10 parts by weight, preferably about 2 to about 7 parts by weight, to 100 parts by weight of the blended rubber. The organic peroxide for use in the invention includes, for example, t-butyl hydroperoxide, cumene hydroperoxide, di-t-butyl peroxide, t-butyl cumyl peroxide, dicumyl peroxide, 2,5-dimethyl-2,5-di(t-butylperoxy)hexane, 2,5-dimethyl-2,5-di(t-butylperoxy)hexine-3,1,3-bis(t-butylperoxyisopropyl)benzene, 1,1-bis(t-butylperoxy)-3,3,5-benzene, 1,1-bis(t-butylperoxy)-3,3,5-trimethylcyclohexane, n-butyl-4,4-bis(t-butylperoxy)valerate, benzoyl peroxide, p-chlorobenzoyl peroxide, 2,4-dichlorobenzoyl peroxide, t-butyl peroxybenzoate, t-butylperoxy isopropyl carbonate, t-butyl benzoate, etc.

The EPDM composition comprising the foregoing respective blend components can further contain 5-50 parts by weight, preferably 10-30 parts by weight, of zinc oxide or titanium oxide on the basis of 100 parts by weight of the blended rubber to further improve the compression set characteristics.

A cross-linking aid comprising a polyfunctional unsaturated compound such as triallyl isocyanurate, triallyl cyanurate, ethylene glycol dimethacrylate, trimethylolpropane trimethacrylate, N,N′-m-phenylene dimaleimide, etc., a reinforcing agent or a filler comprising various carbon black or white carbon, an antioxidant, etc. are further added thereto if necessary, besides the blend components, then the composition is kneaded by any kneading means, such as mixing rolls, a Banbury mixer, various kneaders, etc., and the composition thus kneaded is subjected to cross-linking molding typically by compression molding, injection molding, etc., while heating at temperatures of about 100° to about 200° C. for about 30 seconds to about 2 hours.

### EXAMPLES

The present invention will be described in detail below, referring to Examples.

### Example 1

| | Parts by weight |
|---|---|
| ENB-copolymerized EPDM (EPT4070, a product | 70 |
| made by Mitsui Chemical Co., Ltd.) | |
| DCPD-copolymerized EPDM (EPT1045, a product | 30 |
| made by the same company as above) | |
| Dicumyl peroxide | 5 |
| SRF carbon black | 70 |
| Amine-based antioxidant (Nocrack white, a product | 1.5 |
| made by Ouchi-Shinko Chemical Co., Ltd.) | |
| Paraffinic process oil (PW380, a product made by | 5 |
| Idemitsu Petrochemical Co., Ltd.) | |

The foregoing respective blend components were kneaded by a kneader, and the resulting kneading product was subjected to cross-linking molding at 180° C. for 6 minutes to make test pieces (150 mm×150 mm×20 mm) and G25-sized O rings. The resulting test pieces and O rings were subjected to tests according to the following test items.

Normal physical properties: according to JIS K6253 and K6251 (using the test pieces)

Hot water immersion test: according to JIS K6258 (using the test pieces)

Changes in the normal state physical properties following immersion in hot water at 200° C. for 500 hours and at 300° C. for 24 hours, respectively, were determined

Hot water compression set according to JIS K6262 (using the G25-sized O rings, compression ratio: 25%)

Compression sets following immersion in hot water at 200° C. for 500 hours and at 300° C. for 24 hours, respectively, were determined

### Example 2

In Example 1, the amounts of ENB-copolymerized EPDM and DCPD-copolymerized EPDM were changed to 30 parts by weight and 70 parts by weight, respectively.

### Example 3

In Example 1, 20 parts by weight of zinc oxide was further added thereto.

### Example 4

In Example 1, the amounts of ENB-copolymerized EPDM and DCPD-copolymerized EPDM were changed to 50 parts by weight and 50 parts by weight, respectively, and 20 parts by weight of titanium oxide was added thereto.

### Comparative Example 1

In Example 1, the amounts of ENB-copolymerized EPDM was changed to 100 parts by weight, and no DCPD-copolymerized EPDM was used at all.

### Comparative Example 2

In Example 1, the amounts of DCPD-copolymerized EPDM was changed to 100 parts by weight, and no ENB-copolymerized EPDM was used at all.

### Comparative Example 3

In Example 1, the amounts of ENB-copolymerized EPDM and DCPD-copolymerized EPDM were changed to 90 parts by weight and 10 parts by weight, respectively, and 20 parts by weight of titanium oxide was added thereto.

### Comparative Example 4

In Example 1, the amounts of DCPD-copolymerized EPDM and ENB-copolymerized EPDM were changed to 90 parts by weight and 10 parts by weight, respectively.

Results obtained from the foregoing Examples and Comparative Examples are given in the following Table.

| TABLE | | | | | | | |
|---|---|---|---|---|---|---|---|
| Test Item | | | | | | | |
| | | | | Comp. | Comp. | Comp. | Comp. |
| Ex. 1 | Ex. 2 | Ex. 3 | Ex. 4 | Ex. 1 | Ex. 2 | Ex. 3 | Ex. 4 |

[Normal state physical properties]

| | | | | | | | | |
|---|---|---|---|---|---|---|---|---|
| Hardness (Duro A) | 80 | 80 | 80 | 80 | 81 | 80 | 80 | 81 |
| Tensile strength (MPa) | 21.8 | 21.2 | 22.1 | 21.7 | 21.6 | 19.6 | 21.0 | 20.7 |
| Elongation (%) | 160 | 160 | 170 | 170 | 180 | 180 | 180 | 170 |

[Hot water Immersion test]

| | | | | | | | | |
|---|---|---|---|---|---|---|---|---|
| (200° C., 500 hrs) | | | | | | | | |
| Hardness change (points) | −3 | −3 | −3 | −3 | −3 | −3 | −3 | −3 |
| Percent change in tensile | −10 | −8 | −8 | −7 | −9 | −5 | −8 | −4 |
| strength (%) | | | | | | | | |
| Percent change in elongation (%) | +15 | +14 | +13 | +11 | +10 | +8 | +12 | +10 |
| Percent change in volume (%) | +1.5 | +1.5 | +1.6 | +1.5 | +2.0 | +1.5 | +1.7 | +1.4 |
| (300° C., 24 hrs) | | | | | | | | |
| Hardness change (points) | −12 | −11 | −10 | −10 | −17 | −9 | −15 | −10 |
| Percent change in tensile | −40 | −41 | −38 | −36 | −50 | −29 | −52 | −33 |
| strength (%) | | | | | | | | |
| Percent change in elongation (%) | +60 | +55 | +57 | +55 | +100 | +44 | +93 | +47 |
| Percent change in volume (%) | +3.5 | +3.3 | +3.0 | +3.1 | +6.2 | +4.0 | +5.5 | +3.8 |

[Hot water compression set]

| | | | | | | | | |
|---|---|---|---|---|---|---|---|---|
| 200° C., 500 hrs (%) | 42 | 41 | 35 | 36 | 40 | 53 | 40 | 48 |
| 300° C., 24 hrs (%) | 73 | 72 | 67 | 67 | 87 | 84 | 84 | 80 |

It is apparent from the foregoing results that in hot water immersion tests and hot water compression set tests at 200° C. for 500 hours and at 300° C. for 24 hours, respectively, all the Examples well-balanced characteristics were obtained, whereas in hot water compression set tests of all the Comparative Examples, particularly at 300° C. for 24 hours, poor characteristics were obtained. Results of hot water immersion tests at 300° C. for 24 hours of Comparative Examples 1 and 3 showed particularly large percent changes in elongation.

1. A hot water resistant seal part having a compression set of less than 80% after immersion in hot water at 300° C. for 24 hours, which hot water resistant seal is obtained by vulcanization molding an EPDM composition, which comprises 100 parts by weight of blend rubber consisting of 20-80% by weight of EPDM containing 5-ethylidene-2-norbornene [ENB] as one type of diene component and 80-20% by weight of EPDM containing dicyclopentadiene [DCPD] as another type of diene component, and 0.5-10 parts by weight of an organic peroxide.

2. A hot water resistant seal part according to claim 1, wherein the EPDM composition further comprises 5-50 parts by weight of zinc oxide or titanium oxide.

3-8. (canceled)
